(19) United States
(12) Patent Application Publication
(10) Pub. No.: US 2008/0221804 A1
(43) Pub. Date: Sep. 11, 2008

(54) System of Processing Patient Medical Data

(75) Inventors: Clare JONES, Buckinghamshire (GB); Kristin Schmiedehausen, Buckenhof (DE)

Correspondence Address: CROWELL & MORING LLP;INTELLECTUAL PROPERTY GROUP, P.O. BOX 14300, WASHINGTON, DC, 20044-4300, US

(73) Assignee: Siemens Medical Solutions USA, Inc., Malvern, PA (US)

(21) Appl. No.: 12/043,415

(22) Filed: Mar. 6, 2008

(30) Foreign Application Priority Data
Mar. 6, 2007 (GB) 0704215.3

(51) Int. Cl. G06F 19/00

(52) U.S. Cl. 702/19

(57) ABSTRACT

A system is described for assisting in the interpretation of medical images by making available information derived from other tests such as in vitro testing. In a preferred embodiment, an in vitro diagnostic testing device is integrated with a scanner such as a Positron Emission Tomography (PET) device so that both types of data can be simultaneously acquired and presented to the diagnosing physician.

The invention is concerned with systems for performing diagnoses or risk assessment of patients using a range of clinical test results.

Medical imaging techniques are an invaluable tool in the diagnosis and risk assessment of patients. Some modalities such as Positron Emission Tomography (PET) or Single Photon Emission Computed Tomography (SPECT) provide useful information concerning metabolic function of the patient whereas others such as Magnetic Resonance Imaging (MRI) and Computerised Tomography (CT) provide information about anatomical structure.

With all of these techniques, a sustantial amount of complementary information is available from in-vitro tests such as blood or other body fluid analysis. Such information could alter the presentation of or assist in the interpretation of medical imaging results and in the planning of therapeutic regimes.

However, despite the availability of this supplementary information, interpretation of medical images is usually performed principally on the basis of the image content and, to a lesser extent, the incorporation of additional information passed on by the referring physician. It is uncommon for the results of additional tests to be available at the imaging centre despite the fact that, for certain types of diagnostic indications, such information may be critical.

This is principally because existing systems and apparatus do not facilitate the making available of the various data simultaneously. The two sets of data (imaging and in-vitro) are typically acquired at different locations and at different times. This time difference gives rise to the additional problem that the patient's condition may have changed between the two tests.

Failure to consider images and such critical information increases the likelihood of: inaccurate diagnosis/prognosis;

choice of sub-optimal or ineffective disease management regime or lifestyle recommendations and
increased time and, or expense during the diagnostic process.

There is, therefore, a need for a system which makes readily available the results of in vitro testing to the physician during image analysis.

According to the invention, a system for assisting in the interpretation of medical images comprises the features set out in claim 1, attached hereto.

The invention provides for integration of in vitro diagnostic measurements with medical imaging data. The availability of the whole complement of results may improve: image interpretation;

specificity/sensitivity of the image study;
understanding the basis for, and the ability to improve, image quality;
calculation of prognostic scores or assessment of response to therapy; therapy planning;
understanding of the Adsorption, Distribution, Metabolism and Excretion (ADME) and toxicological properties of drugs and
the time required for a workflow.

In addition, the invention reduces the administrative burden and risk of error associated with the transfer of information from one location (e.g. where body fluid analysis takes place) to another (e.g where image interpretation is carried out).

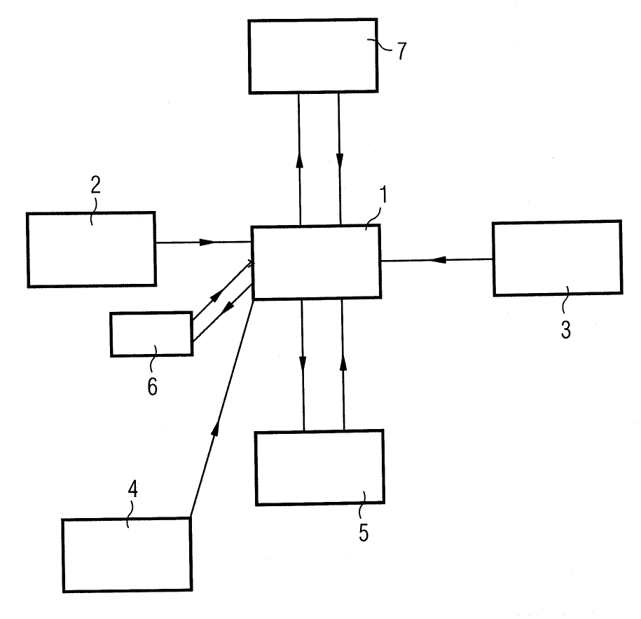

The invention will now be described by non-limiting example, with reference to FIG. 1 which shows, in schematic form, a basic implementation of the invention.

The following examples outline the workflow and steps involved in calculating a prognostic or response to therapy score based on results from in vivo-imaging and in vitro diagnostic (IVD) tests. The imaging and IVD tests may be performed on the same day or at different times. Changes in results between the same type of test performed at different timepoints may also be used in calculating a prognostic/response to therapy score.

### EXAMPLE 1

### Cardiac Prognostic Score

Note: this is a suggested workflow, but some steps may occur concurrently, or in a different order to that presented below. Some steps may be omitted.

1. Patient presents at the healthcare provider setting for myocardial infarction risk assessment. They may be self-referred, or referred by a physician due to an intermediate or high Framingham (or other basic) risk assessment.

2. Basic patient information is transcribed manually into a data management system, or existing information about the patient is downloaded from a HIS or other data management system.

2. Blood samples are taken and some/all of the following in vitro diagnostic tests are performed:
Cholesterol (Total, High density lipoprotein (HDL) and Low density lipoprotein (LDL))
Triglycerides
Ureic Acid
Blood Glucose level
Hb1Ac level (In case of diabetic patients)
Cholesterol markers
High sensitivity CRP
Microalbumin/creatinine ratio (because it's in various guidelines for diabetes and often associated with CVD)
Fibrinogen
Cystatin-C
BNP/NT-proBNP
Homocysteine
IL-6
Cardiac specific Troponin
APO lipoproteins
CKMB and myoglobin
D-Dimer
Oxidized LDL
PAPP-A
IGF-1

### Additional Tests May be Added.

The concentrations of each of these factors are determined either immediately using a ‘point-of-care’ system, or after processing with samples from other patients in a batch on standard clinical laboratory instrumentation.

The results are automatically transferred to the prognostic score calculation software, together with patient identifier, date and other basic information. Alternatively, the results of these tests may be manually transferred to the prognostic/diagnostic score calculation software.

3. Blood pressure is determined and automatically passed to the prognostic score calculation software together with patient identification details and date.

4. An Electro Cardiogram (ECG) may be performed and the results automatically passed to the prognostic score calculation software together with patient identification details and date.

5. Pharmacological stress (if appropriate) and imaging agents (for CT and SPECT) are administered to patient

6. SPECT (rest+/−stress)+/−CT imaging studies are performed either using a hybrid SPECT/CT or dedicated SPECT followed by CT (or vice versa).

7. The images generated are visually inspected to confirm that image quality is acceptable.

8. The images are digitally displayed and semi quantitative methods (software aided or based on visual assessment) are used to calculate the summed stress score and a summed rest score. [this is commonly performed using a 20-segment model (or the American Heart Association (AHA) recommended 17 segment model) of the left ventricle and a 5 point scale (0, normal uptake; 1, mildly reduced uptake; 2, moderately reduced uptake; 3, severely reduced uptake; 4, no uptake)]. These values are automatically passed to the prognostic score calculation software together with patient identifier, date and other basic information.

9. Ejection fraction is calculated from the SPECT images using automated third party software such as the packages known as 4 DM_SPECT, ‘Cedars’ or ‘Emory’. This value is automatically passed to the prognostic score calculation software together with patient identifier, date and other basic information.

10. Using semi-automated software, coronary artery calcium scoring is performed on the CT image. This generates a single number. This value is automatically passed to the prognostic score calculation software together with patient identifier, date and other basic information.

11. The prognostic score calculation software calculates a score for the patient based on the results of the tests that have been sent to it and the basic patient information. [Note: the software includes appropriate checks to confirm that the input parameters are from studies on the right patient conducted at the right time].

There is evidence in the literature of prognostic score based on either patient age, smoking history etc, IVD tests, or calcium scoring or Myocardial perfusion scan (MPS) studies, but not on all of these combined. Therefore an extensive study(ies) would need to be performed in order to generate the data from which to calculate prognostic score. It is quite likely that the studies would need to be prospective.

12. The resulting score is associated with the electronic or paper based patient record and also associated with each of the studies on which it was based ie. The SPECT, CT and IVD studies.
13. The results of IVD tests are also stored associated with the image(s) using DICOM secondary capture, DICOM structured report, non-DICOM format such as HL7, text or other format.

### Variations:

PET may be used in place of SPECT.

A dual isotope SPECT study (DISA) may also be performed (+/−CT study) where perfusion and viability are assessed using ⁹⁹Tc and 18F-Fluorodeoxyglucose (FDG).

The final prognostic score may be calculated based on the change in any of the input parameters between this study and a previous study.

Rather than the results of each the tests being automatically passed to the calculation software, the calculation software could search PACS, HIS, or Laboratory management system (LIMS) or other information management systems for the results of the studies performed on the patient (based on patient identifier) and identify the values required for the calculation. Alternatively, the results of each study could be manually entered into the software.

### CARDIAC REFERENCES

“Prediction of Coronary Heart Disease Using Risk Factor Categories” Peter W. F. Wilson, Ralph B. D'Agostino, Daniel Levy, Albert M. Belanger, Halit Silbershatz and William B. Kannel. Circulation 1998; 97; 1837-1847
“Coronary Artery Calcium Score Combined With Framingham Score for Risk Prediction in Asymptomatic Individuals” Philip Greenland, MD; Laurie LaBree, MS; Stanley P. Azen, PhD; Terence M. Doherty, BA; Robert C. Detrano, MD, PhD. JAMA Jan. 14, 2004; 291(2):210-215
“Quantification of coronary artery calcium using ultrafast computed tomography” A S Agatston, W R Janowitz, F J Hildner, N R Zusmer, M Viamonte Jr, and R Detrano. J Am Coll Cardiol, 1990; 15:827-832
“SPECT: Risk Stratification by the Amount of Stress-induced Ischemia and the Poststress Ejection Fraction” Tali Sharir, Guido Germano, Xingping Kang, Howard C. Lewin, Romalisa Miranda, Ishac Cohen, Raluca D. Agafitei, John D. Friedman, and Daniel S. Berman THE JOURNAL OF NUCLEAR MEDICINE•Vol. 42•No. 6•June 2001

### EXAMPLE 2

### Alzheimer's Diagnosis/Therapy Prediction Score

Patient's genotype, family history or clinical symptoms suggest that they are at risk of developing Alzheimer's or are in the early stages of the disease. The patient is referred for further investigation/regular screening in order to determine the risk that the patient will go on to develop Alzheimer's, or to make a differential diagnosis between different forms of dementia.

Similarly, studies may be performed to predict and then determine the patient's response to a particular therapeutic regimen.

Note: this is a suggested workflow, but some steps may occur concurrently, or in a different order to that presented below. Some steps may be omitted.

1. Basic patient information, including any history of cardiovascular disease is transcribed manually into a data management system, or existing information about the patient is downloaded from a HIS or other data management system.

2. Mini-mental state examination (MMSE) or similar clinical examination is performed and the results recorded on the patients electronic or paper record. The result is automatically passed to the diagnosis/therapy prediction calculation software together with patient identifier, date and other basic information.

3. Blood samples and/or cerebrospinal fluid are taken and some/all of the following in vitro diagnostic tests are performed:
Cholesterol (HDL and LDL)
Beta amyloid (various isoforms particularly 38, 40 and 42)
Soluble amyloid
Total tau and phosphorylated tau
Estradiol
Oestrogen
CRP
ApoE genotype (if not already known)
Gene expression profiling

Additional tests may be added (several new blood or CSF based biomarkers have recently been identified).

The concentrations of each of these factors are determined either immediately using a ‘point-of-care’ system, or after processing with samples from other patients in a batch on standard clinical laboratory instrumentation.

The results are automatically transferred to the diagnosis/therapy prediction calculation software, together with patient identifier, date and other basic information.

4. Blood pressure is determined and automatically passed to the diagnosis/therapy prediction calculation software together with patient identification details and date.

5. MRI (DCI images, reference below) and PET (using either FDG in order to assess alternation in Glucose metabolism), 18-fluoro-dimethyl-amino-dicyano-naphthalene-propene (FDDNP), PIB or other agents known to be used in assessment of Alzheimer's/amyloid burden) studies are performed. [SPECT imaging (with HMPAO or ECD) may also be used as an alternative to PET]

6. All images generated are digitally displayed and visually inspected to confirm that image quality is acceptable.

7. The images are digitally displayed and automatic or semi automatic methods are used to calculate parameters from the MR images such as hippocampal volume, ventricle volume and others. These values are automatically passed to the diagnosis/therapy prediction calculation software together with patient identifier, date and other basic information.

8. From the PET, or PET registered with MR images, the uptake of the tracer in the patient is compared with that in other age matched subjects using automatic software such as Scenium (Siemens). The results are automatically passed to the diagnosis/therapy prediction calculation software.

9. The diagnosis/therapy prediction software calculates the likely progression of the patient's disease based on the results of the tests that have been sent to it and the basic patient information. [Note: the software includes appropriate checks to confirm that the input parameters are from studies on the right patient conducted at the right time]. Consulting a data base of similar cases, or results from clinical trials, the software predicts the optimal course of therapy or if a particular therapy is selected by the physician, the software predicts the likely outcome of that therapy.

At present there are limited therapeutic options for treating dementia. Therefore extensive study(ies) would need to be performed in order to generate the data from which to diagnose or calculate therapy prediction score. It is quite likely that the studies would need to be prospective. There are many therapies in development for Alzheimer's and the results from clinical trials may also be used in compiling the appropriate databases.

10. The resulting score is associated with the electronic or paper based patient record and also associated with each of the studies on which it was based ie. The PET, MRI and IVD studies.

### Variations:

SPECT may be used in place of PET.

The final therapy predictive score may be calculated based on the change in any of the input parameters between this study and a previous study.

Rather than the results of each the tests being automatically passed to the calculation software, the calculation software could search PACS, HIS, or LIMS or other information management systems for the results of the studies performed on the patient (based on patient identifier) and identify the values required for the calculation. Alternatively, the results of each study could be manually entered into the software.

### NEUROLOGICAL REFERENCES

K Herholz et al, Discrimination between Alzheimer Dementia and Controls by Automated Analysis of Multicenter FDG PET Neuroimage 17, 302-316, 2002
Hiroshi Matsuda, Noriyuki Kitayama, Takashi Ohnishi, Takashi Asada, Seigo Nakano, Shigeki Sakamoto, Etsuko Imabayashi, and Asako Katoh Longitudinal Evaluation of Both Morphologic and Functional Changes in the Same Individuals with Alzheimer's Disease J. Nucl. Med. 2002 43: 304-311.
L. Mosconi et al Functional Interactions of the Entorhinal Cortex: An 18F-FDG PET Study on Normal Aging and Alzheimer's Disease Journal of Nuclear Medicine Vol. 45 No. 3 382-392, 2004
Kimberly M. Ray, MD, Huali Wang, MD, PhD, Yong Chu, PhD, Ya-Fang Chen, MD, Alberto Bert, PhD, Anton N. Hasso, MD, Min-Ying Su, PhD
Mild Cognitive Impairment: Apparent Diffusion Coefficient in Regional Gray Matter and White Matter Structures. Radiology 2006; 241:197-205

### EXAMPLE 3

### Oncology

The results of in vitro diagnostic tests may be combined with the results of imaging studies for several applications in oncology, most notably monitoring disease progression, response to therapy or toxicity assessment during chemotherapy or radiotherapy. The toxicity example is further explored here.

The patient's IVD parameters as well as imaging techniques are crucial in assessment of therapy associated toxicity that can be the limiting factor for Chemotherapy and Radiotherapy continuation. Depending on the side effects, the therapy may have to be transiently discontinued or even stopped, or a new therapeutic regimen might be necessary.

Note: this is a suggested workflow, but some steps may occur concurrently, or in a different order to that presented below. Some steps may be omitted.

1. Basic patient information is transcribed manually into a data management system, or existing information about the patient is downloaded from a HIS or other data management system.

2. Chemotherapy regimen/and or radiotherapy dose planning/dose information are results recorded on the patient's electronic or paper record. The result is automatically passed to the toxicity calculation software together with patient identifier, date and other basic information.

3. Blood samples and/or cerebrospinal fluid are taken and some/all of the following in vitro diagnostic tests are performed:
White (differential) and red blood (inclusive Reticulocytes and Normocytes) cells
Platelets
Coagulation parameters
Creatinine and Glomerular Filtration Rate (GFR)
ADH, Gamma GT, Glutamate dehydrogenase (GLDH), Glutamic-Oxalocetic Transaminase—AST (GOT) and Bilirubine
LDH

Additional tests may be added, in particular, those for tumour specific markers. The concentrations of each of these factors are determined either immediately using a ‘point-of-care’ system, or after processing with samples from other patients in a batch on standard clinical laboratory instrumentation.

The results are automatically transferred to the toxicity assessment software together with patient identifier, date and other basic information.

4. Blood pressure is determined and automatically passed to the toxicity prediction calculation software together with patient identification details and date.

5. Images such as ultrasound, planar X ray and Multiple gated acquisition (MUGA) scan that assess toxic side effects are performed.

6. PET and CT images (and other techniques that are used for therapy response monitoring) may also be performed.

7. All images generated are digitally displayed and visually inspected to confirm that image quality is acceptable.

8. According to the extent of toxic side effects and the therapy response, the software calculates a toxicity score and suggests dose modification, reduction of, or even discontinuation of therapy. The degree of toxicity is colour coded.

9. The resulting score is associated with the electronic or paper based patient record and also associated with each of the studies on which it was based.

### Variations:

The final toxicity score may be calculated based on the change in any of the input parameters between this study and a previous study.

Rather than the results of each the tests being automatically passed to the calculation software, the calculation software could search PACS, HIS, or LIMS or other information management systems for the results of the studies performed on the patient (based on patient identifier) and identify the values required for the calculation. Alternatively, the results of each study could be manually entered into the software.

Referring to FIG. 1, the invention includes a processor 1 arranged to receive information from a source of medical image data 2, and from a source of in vitro testing results 3. The processor also receives information from a source of other patient data 4.

Applications are loaded on ROM 5 which, when executed, by processor 1 in conjunction with RAM provide for calculation of diagnosis, risk scores and the provision of recommendations for treatment, therapy or other further action. The applications may also compile the medical image data and the in vitro testing results in a single presentation for easy reference by the diagnosing physician.

Man Machine Interface (MMI) 7 includes means, such as a display screen, for presenting information to a user and means, such as a keyboard and, or mouse, for the user to input information. Thus, through MMI, the user may input further information, initiate the applications and view results thereof.

The invention as illustrated in FIG. 1 could be implemented as a personal computer, loaded with the necessary applications and in communication with the information sources 2 and 3. Such communication could be effected by any of a number of means including wireless communication, Local Area Network or larger Network up to and including the internet or GRID.

Informations sources 2 and 3 could be the original sources where the information is generated (i.e. a medical imaging apparatus and an in vitro diagnostic testing device respectively) or they could be a repository where the requisite information is stored.

In another embodiment, the computing hardware would be integrated with the medical scanning equipment and would be in communication with the source of in vitro testing results 3. During a typical course of investigation/treatment of a patient, the in vitro testing would be carried out prior to the medical imaging. By this embodiment, the results of the in vitro testing can be retrieved at the time and location of image acquisition, reconstruction or interpretation so that all information can be considered in presentation or interpretation of the image.

In a most preferred embodiment, the in vitro diagnostic testing device and scanning equipment are integrated, along with the necessary computing hardware. In addition to making all of the relevant information readlily available, this arrangement lends itself to carrying out the complete range of tests during a single patient visit. This in turn avoids the problem of changes to the patient's condition between tests; reduces the administrative burden associated with two separate visits and is more convenient for the patient.

1. A system for processing patient medical data comprising:
means for receiving data representing the results of a medical imaging scan;
means for receiving data representing the results of in vitro tests and
means for presenting said results of a medical imaging scan and results of in vitro tests simultaneously.

2. A system according to claim 1, and further including means for calculating a risk score, diagnosis or therapeutic regimen from the results of a medical imaging scan and results of in vitro tests.

3. A system according to claim 1, where the scan is a Positron Emission Tomography (PET) scan.

4. A system according to claim 1, where the scan is a Single Photon Emission Computed Tomography (SPECT) scan.

5. A system according to claim 1, where the scan is a Magnetic Resonance Imaging (MRI) scan.

6. A system according to claim 1, where the scan is a Computerised Tomography (CT) scan.

7. A system according to claim 1, where the scan is an ultrasound scan.

8. A system according to claim 1, incorporated in an in vitro diagnostic testing device.

9. A system according to claim 1, incorporated in a medical scanner.

10. A system according to claim 9, and further incorporating an in vitro diagnostic testing device.
